(19) United States
(12) Patent Application Publication
(10) Pub. No.: US 2026/0044331 A1
(43) Pub. Date: Feb. 12, 2026

(54) MOUNTING IMAGES FOR UNPRIVILEGED USERS

(71) Applicant: Red Hat, Inc., Raleigh, NC (US)

(72) Inventors: Giuseppe Scrivano, Milan (IT); Alexander Larsson, Stockholm (SE)

(21) Appl. No.: 18/796,193

(22) Filed: Aug. 6, 2024

(51) Int. Cl. G06F 8/61; G06F 21/64

(52) U.S. Cl. CPC G06F 8/63; G06F 21/64

(57) ABSTRACT

Disclosed are techniques for allowing unprivileged users to mount image files in a secure manner. A service for validating image files may run as a privileged (i.e., root) process in user space of an operating system. The service may receive a contents file describing an image file to be mounted and mount information for the image file. The service may generate an image binary file based on the contents file and determine whether the image binary file is valid using the mount information. In response to determining that the image binary file is valid, the service may send a request to the kernel space of the operating system to mount the image binary file.

### TECHNICAL FIELD

Aspects of the present disclosure relate to mounting image files, and more particularly, to allowing unprivileged users to mount image files in a secure manner.

### BACKGROUND

An operating system may manage the execution of components such as software and applications, and/or may manage access to hardware (e.g., processors, memory, storage devices etc.). An operating system may include a kernel space (for running e.g., a privileged operating system kernel, kernel extensions and device drivers) and a user space supporting the execution of one or more applications, typically one address space per application. The kernel space may perform several operating system functionalities, including but not limited to process management, hardware interfaces, access control and the like. Functions executing within the kernel space may execute with an elevated privilege and may manage the administration of the operating system.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the scope of the described embodiments.

FIG. 1 is a block diagram that illustrates an example system, in accordance with some embodiments of the present disclosure.

FIG. 2 is a block diagram illustrating the system of FIG. 1 implementing an image file validation service that performs some of the image file mount techniques described herein, in accordance with some embodiments of the present disclosure.

FIG. 3 is a block diagram illustrating the image file validation service of FIG. 2 validating an image binary file, in accordance with some embodiments of the present disclosure.

FIG. 4 is a block diagram illustrating the file validation service of FIG. 1 performing some of the image file mount techniques described herein, in accordance with some embodiments of the present disclosure.

FIG. 5 is a flow diagram of a method for allowing unprivileged users to mount image files in a secure manner, in accordance with some embodiments of the present disclosure.

FIG. 6 is a block diagram of an example computing device that may perform one or more of the operations described herein, in accordance with some embodiments of the disclosure.

### DETAILED DESCRIPTION

In an operating system, the ability to mount image files is typically restricted to privileged users with the exception of a few image files that are mountable in a user namespace. Image files that are mountable in a user namespace usually do not have an on-disk format. More complex image files that do have an on-disk format are not mountable for unprivileged users due to security concerns. For example, corrupted or malicious image files could exploit kernel space vulnerabilities. Thus, the ability of unprivileged users to mount more complex image files is limited. What is needed is a service that can balance the need for security with the functionality and convenience of allowing unprivileged users to mount image files.

The present disclosure addresses the above-noted and other deficiencies by providing techniques for allowing unprivileged users to mount image files in a secure manner. A system service for validating image files may run as a privileged (i.e., root) process in user space of an operating system. The system service may receive a contents file describing an image file that an unprivileged user wishes to mount and mount information for the image file. The contents file may include a name of the image file, a location of the image file and a location of the image file payload. The contents file may provide its information in a format that is easily parsed such as a JavaScript object notation (JSON) file. The system service may generate an image binary file based on the contents file and determine whether the image binary file is valid using the mount information. The mount information may include a destination mount namespace for the image file, a mount target location for the image file and an expected checksum for the image file. In response to determining that the image binary file is valid, the system service may send a request to the kernel space of the operating system to mount the image binary file.

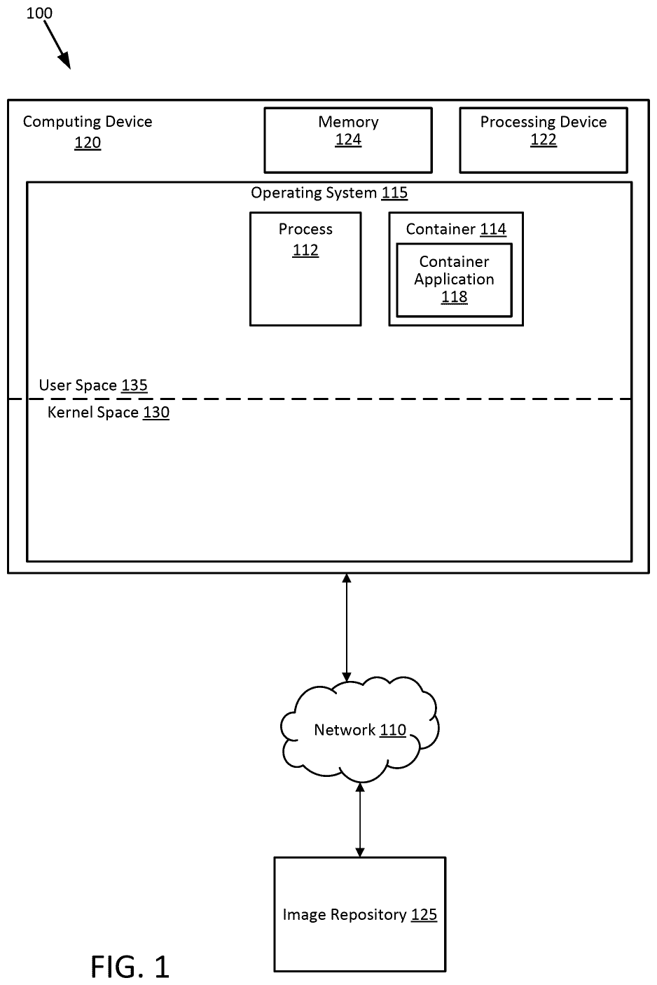

FIG. 1 is a block diagram that illustrates an example system 100, in accordance with some embodiments of the present disclosure. As illustrated in FIG. 1, the system 100 includes computing device 120 and an image repository 125. The computing device 120 (and the image repository 125) may include hardware such as processing device 122 (e.g., processors, central processing units (CPUs)) and memory 124 (e.g., random access memory (RAM), hard-disk drive (HDD), and other hardware devices (e.g., network interfaces, sound card, video card, etc.—not shown).

The computing device 120 and the image repository 125 may be coupled to each other (e.g., may be operatively coupled, communicatively coupled, may communicate data/messages with each other) via network 110. Network 110 may be a public network (e.g., the internet), a private network (e.g., a local area network (LAN) or wide area network (WAN)), or a combination thereof. In one embodiment, network 110 may include a wired or a wireless infrastructure, which may be provided by one or more wireless communications systems, such as a WIFI™ hotspot connected with the network 110 and/or a wireless carrier system that can be implemented using various data processing equipment, communication towers (e.g., cell towers), etc. The network 110 may carry communications (e.g., data, message, packets, frames, etc.) between the image repository 125 and the computing device 120. As used herein, the term “and/or” includes any and all combinations of one or more of the associated listed items.

The computing device 120 may comprise any suitable type of computing device or machine that has a programmable processor including, for example, server computers, desktop computers, laptop computers, tablet computers, smartphones, set-top boxes, etc. In some examples, the computing device 120 may respectively comprise a single machine or may include multiple interconnected machines (e.g., multiple servers configured in a cluster). The image repository 125 and/or the computing device 120 may be implemented by a common entity/organization or may be implemented by different entities/organizations. For example, computing device 120 may be operated by a first company/corporation and the image repository 125 may be operated by a second company/corporation. The image repository 125 and the computing device 120 may each execute or include an operating system (OS).

Though illustrated as a single element, the image repository 125 may be or may include a distributed storage network. In some embodiments, the image repository 125 may be or include a plurality and/or cluster of storage hardware, each including a server and a corresponding storage medium. In some embodiments, the image repository 125 may implement storage on a single distributed computer cluster and provide integrated interfaces for at least one of: object-level, block-level, or file-level storage.

The computing device 120 may include an operating system 115. The operating system 115 of the computing device 120 may manage the execution of other components (e.g., software, applications, etc.) and/or may manage access to the hardware (e.g., processors, memory, storage devices etc.) of the computing device 120. Operating system 115 may include a kernel space 130 (for running e.g., a privileged operating system kernel, kernel extensions and device drivers) and a user space 135 supporting the execution of one or more applications typically one address space per application. For example, in FIG. 1, the user space 135 is illustrated with two applications: an executing process 112 and a container application 118 executing within container 114. Though two applications are illustrated in FIG. 1, it will be understood that a plurality of applications may be present. The kernel space 130 may include several operating system functionalities, including but not limited to process management, hardware interfaces, access control and the like. Functions executing within the kernel space 130 may execute with an elevated privilege and may manage the administration of the operating system 115. Examples of operating systems 115 include WINDOWS™, LINUX™, ANDROID™, IOS™, and MACOS™. In some embodiments, the operating system 115 may be, or be part of, a virtual machine executing on the computing device 120.

Containers are active components executing on an operating system that provide an environment for applications to run, while being isolated from any other components of a host machine, network, or data center etc. Multiple containers may execute on a single operating system kernel and share the resources of the hardware on which the operating system is running. All of the files, libraries and dependencies necessary to run applications in a container may be provided by an image file(s). An image file may include one or more layers, where each layer is an image file itself. More specifically, an image file may be comprised of a set of base layers that define the runtime environment, as well as the packages and utilities necessary for a containerized application to run. Such base layers may comprise read-only layers that are never modified. For example, a first layer of an image file used by a computing device 120 may comprise a host OS (including e.g., the OS kernel as well as the relevant packages (not shown) of the host OS including any associated libraries, binary and/or source files etc.), on which applications may run. A second layer may comprise a particular application to execute on a computing device 120 including any relevant packages and utilities necessary for the particular application to run. An image file may be shared by multiple computing devices. The image repository 125 may store a variety of image files (e.g., docker images).

The operating system 115 of the computing device 120 may include a storage driver (not shown in FIG. 1), such as OverlayFS, to manage the contents of an image file including the read only and writable layers of the image file. The storage driver may be a type of union file system which allows a developer to overlay one file system (layer) on top of another. The storage driver may add a new writable (e.g., in-memory) layer on top of the underlying layers (the first and second layers) of the image file and changes may be recorded in the in-memory layer, while the underlying layer(s) remain unmodified. Changes made in the in-memory layer may be saved by creating a new layered image. In this way, multiple devices may share a single image file where the underlying layers are read-only media. However, user space is the memory area where application software and some drivers execute, typically one address space per process. Each user space process normally runs in its own virtual memory space, and, unless explicitly allowed, cannot access the memory of other processes.

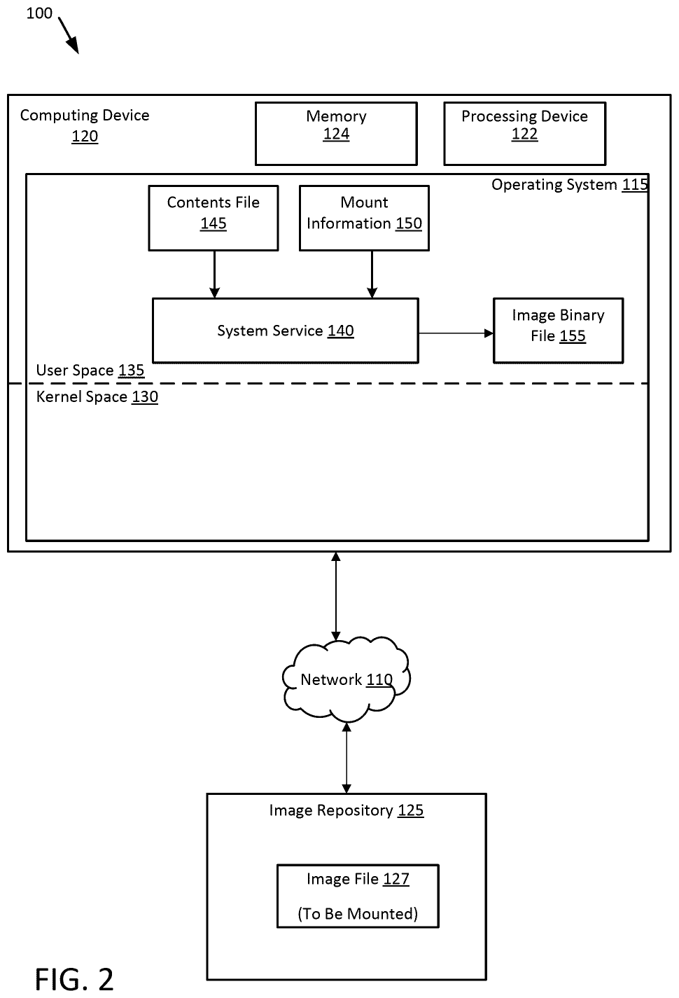

FIG. 2 illustrates the computing device 120, implementing a system service 140 for validating an image file that a user wishes to upload in accordance with some embodiments of the present disclosure. The system service 140 may run in the user space 135 as a privileged service (i.e., runs as the root account on the operating system 115). As shown in FIG. 2, a user may provide the system service 140 with a contents file 145 describing an image file 127 to be mounted, and mount information 150 for the image file. Although illustrated as originating from the image file repository 125, this is not a limitation and the image file 127 may originate from any appropriate source. The contents file 145 may be in a format that is simple to parse (e.g., JSON) to avoid passing complex structures to a privileged environment (the kernel space 130) from an unprivileged environment (the user space 135). In some embodiments, the contents file 145 may comprise text information describing the image file the user wishes to upload. The contents file 145 may include a name of the image file, a location of the image file, a location of the image file payload, and an owner of the image file. The mount information 150 may specify a destination mount namespace for the image file, a mount target location for the image file and an expected checksum of the image file.

In response to receiving the contents file 145 and the mount information 150, the system service 140 may generate an image binary file 155 based on the contents file 145. In some embodiments, the image binary file 155 may comprise a set of read-only image file layers. The system service 140 may validate and mount the image binary file 155.

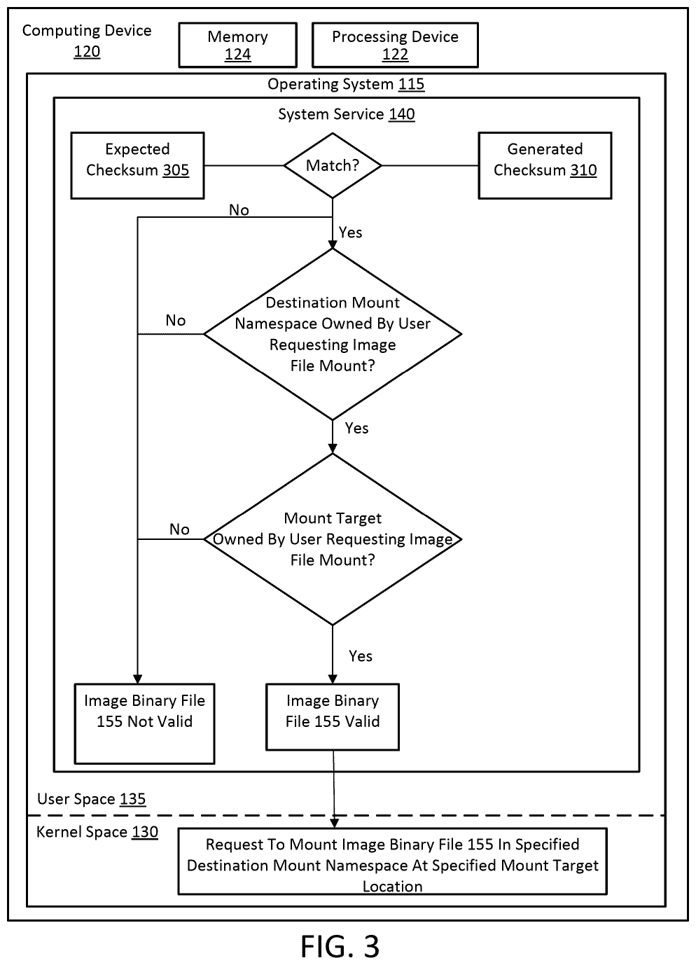

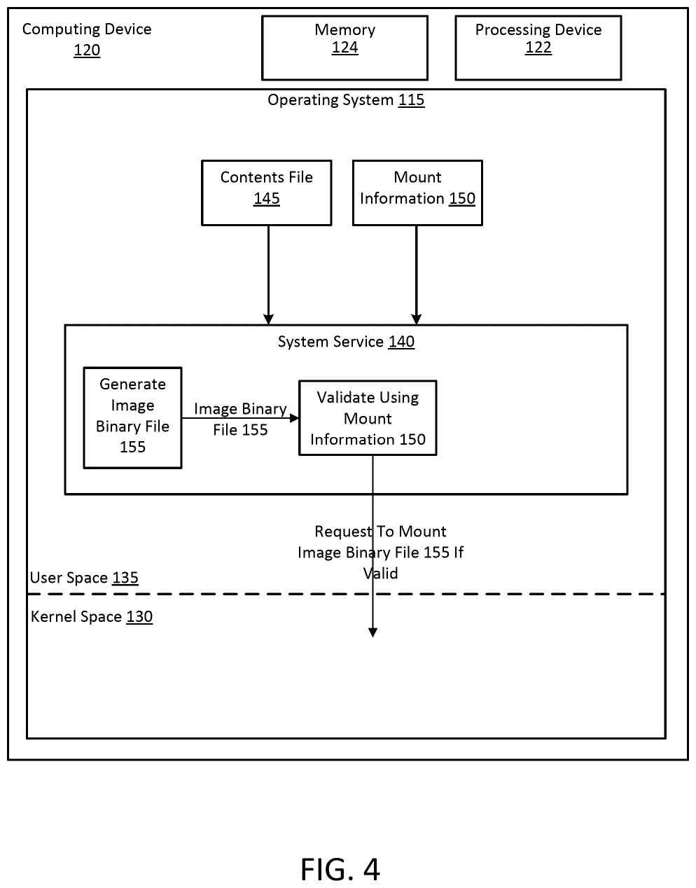

FIGS. 3 and 4 illustrate the system service 140 validating whether the image binary file 155 is valid, in accordance with some embodiments of the present disclosure. In some embodiments, the system service 140 may generate a checksum 310 for the image binary file 155 and compare the generated checksum to the expected checksum 305 specified in the mount information 150. The system service 140 may only mount the image binary file 155 if the expected checksum 305 and the generated checksum 310 match and the other validation conditions discussed below are met. If the expected checksum 305 and the generated checksum 310 do not match, the system service 140 may determine that the image binary file 155 (and thus the image file the user wishes to mount) are not valid.

Upon determining that the expected checksum 305 and the generated checksum 310 match, the system service 140 may continue the process of validating the image binary file 155 by determining whether the destination mount namespace and the mount target location are owned by the user requesting the image file 127 to be mounted. The mount information 150 may include a file descriptor (not shown) that points to the destination mount namespace and the mount target location. The system service 140 may use a system call to query the name of the owner of the destination mount namespace and the mount target location pointed to by the file descriptor to ensure that the user is the owner of the destination mount namespace. The system service 140 may determine that the image binary file 155 is valid if the destination mount namespace and the mount target location are owned by the user requesting the image file 127 to be mounted. Upon determining that the image binary file 155 is valid, the system service 140 may send a request to the kernel space 130 to mount the image binary file 155. The image binary file 155 can be trusted because it is generated by the system service 140 which runs in user space 135 as a privileged (root) process.

In some embodiments, a user may also specify an IDmap configuration for the image file in the mount information 150. User namespaces isolate security-related identifiers and attributes such as user space IDs (also referred to herein as user IDs) and group IDs. A process's user and group IDs can be different inside and outside a user namespace. In particular, a process can have a normal unprivileged user ID outside a user namespace while at the same time having a user ID of 0 inside the namespace. In other words, the process has full privileges for operations inside the user namespace, but is unprivileged for operations outside the namespace. The IDmap configuration may specify a 1-to-1 mapping of a range of contiguous user IDs between two user namespaces. The user may specify the IDmap configuration for the image file in situations where e.g., they want to reuse the image file with different user namespace configurations.

In embodiments where an IDmap configuration is provided as part of the mount information 150, the system service 140 may confirm that the specified user IDs in the IDmap configuration are mapped inside the destination mount namespace prior to mounting the image binary file 155. If they are, the system service 140 may send a request to the kernel space 130 to mount the image binary file 155 in the specified destination mount namespace at the specified mount target location using the specified IDmap configuration.

Embodiments of the present disclosure balance the need for security with the functionality and convenience of allowing unprivileged users to mount image files. Embodiments disclosed herein also allow for any image file including non-trusted ones to be mounted if they are validated, thereby effectively replacing the current use case where random images that are pulled from a registry and run in a container are expected to be signed. The image binary file 155 can be trusted because it is generated by the system service 140 which runs in user space as a privileged (root) process.

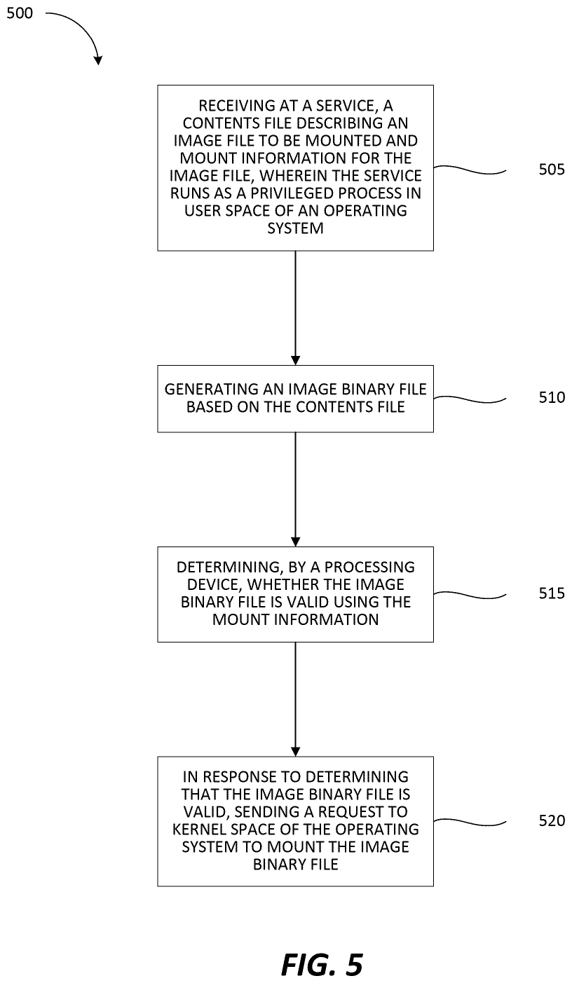

FIG. 5 is a flow diagram of a method 500 for allowing unprivileged users to mount image files in a secure manner, in accordance with some embodiments of the present disclosure. Method 500 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 500 may be performed by a computing device (e.g., computing device 120 illustrated in FIGS. 1 and 2).

Referring simultaneously to FIGS. 2 and 3 as well, the method 500 begins at block 505, where a user may provide the system service 140 with a contents file 145 describing an image file 127 to be mounted, and mount information 150 for the image file. The contents file 145 may be in a format that is simple to parse (e.g., JSON) to avoid passing complex structures to a privileged environment (the kernel space 130) from an unprivileged environment (the user space 135). In some embodiments, the contents file 145 may comprise text information describing the image file the user wishes to upload. The contents file 145 may include a name of the image file, a location of the image file, a location of the image file payload, and an owner of the image file. The mount information 150 may specify a destination mount namespace for the image file, a mount target location for the image file and an expected checksum of the image file.

At block 510, in response to receiving the contents file 145 and the mount information 150, the system service 140 may generate an image binary file 155 based on the contents file 145. In some embodiments, the image binary file 155 may comprise a set of read-only image file layers. The system service 140 may validate and mount the image binary file 155.

At block 515, the system service 140 may validate the image binary file 155 using the mounting information 150. More specifically, the system service 140 may generate a checksum 310 for the image binary file 155 and compare the generated checksum to the expected checksum 305 specified in the mount information 150. The system service 140 may only mount the image binary file 155 if the expected checksum 305 and the generated checksum 310 match and the other validation conditions discussed below are met. If the expected checksum 305 and the generated checksum 310 do not match, the system service 140 may determine that the image binary file 155 (and thus the image file the user wishes to mount) are not valid.

Upon determining that the expected checksum 305 and the generated checksum 310 match, the system service 140 may continue the process of validating the image binary file 155 by determining whether the destination mount namespace and the mount target location are owned by the user requesting the image file 127 to be mounted. The mount information 150 may include a file descriptor (not shown) that points to the destination mount namespace and the mount target location. The system service 140 may use a system call to query the name of the owner of the destination mount namespace and the mount target location pointed to by the file descriptor to ensure that the user is the owner of the destination mount namespace. The system service 140 may determine that the image binary file 155 is valid if the destination mount namespace and the mount target location are owned by the user requesting the image file 127 to be mounted. At block 520, upon determining that the image binary file 155 is valid, the system service 140 may send a request to the kernel space 130 to mount the image binary file 155. The image binary file 155 can be trusted because it is generated by the system service 140 which runs in user space as a privileged (root) process.

In some embodiments, a user may also specify an IDmap configuration for the image file in the mount information 150. User namespaces isolate security-related identifiers and attributes such as user space IDs (also referred to herein as user IDs) and group IDs. A process's user and group IDs can be different inside and outside a user namespace. In particular, a process can have a normal unprivileged user ID outside a user namespace while at the same time having a user ID of 0 inside the namespace. In other words, the process has full privileges for operations inside the user namespace, but is unprivileged for operations outside the namespace. The IDmap configuration may specify a 1-to-1 mapping of a range of contiguous user IDs between two user namespaces. The user may specify the IDmap configuration for the image file in situations where e.g., they want to reuse the image file with different user namespace configurations.

In embodiments where an IDmap configuration is provided as part of the mount information 150, the system service 140 may confirm that the specified user IDs in the IDmap configuration are mapped inside the destination mount namespace prior to mounting the image binary file 155. If they are, the system service 140 may send a request to the kernel space 130 to mount the image binary file 155 in the specified destination mount namespace at the specified mount target location using the specified IDmap configuration.

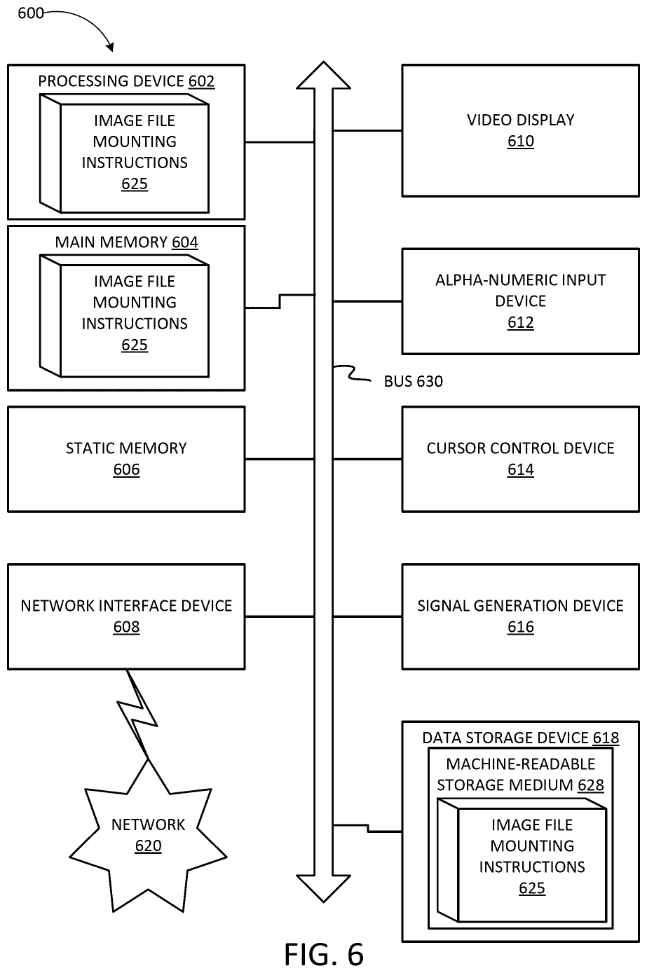

FIG. 6 is a block diagram of an example computing device 600 that may perform one or more of the operations described herein, in accordance with some embodiments of the disclosure. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device (e.g., a general-purpose processor, a PLD, etc.) 602, a main memory 604 (e.g., synchronous dynamic random-access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also include one or more special-purpose processing devices such as an application specific integrated circuit (ASIC), a field programmable gate array (FPGA), a digital signal processor (DSP), network processor, or the like. The processing device 602 may execute the operations described herein, in accordance with one or more aspects of the present disclosure, for performing the operations and steps discussed herein.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Data storage device 618 may include a computer-readable storage medium 628 on which may be stored one or more sets of image file mounting instructions 625 for carrying out the operations described herein, in accordance with one or more aspects of the present disclosure. The image file mounting instructions 625 may also reside, completely or at least partially, within main memory 604 and/or within processing device 602 during execution thereof by computing device 600, main memory 604 and processing device 602 also constituting computer-readable media. The image file mounting instructions 625 may further be transmitted or received over a network 620 via network interface device 608.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that cause the machine to perform the methods described herein. The term “computer-readable storage medium” shall accordingly be taken to include, but not be limited to, solid-state memories, optical media, and magnetic media.

Unless specifically stated otherwise, terms such as “receiving,” “determining,” “generating,” “mounting,” “comparing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting. As used herein, the term “and/or” includes any and all combination of one or more of the associated listed items.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times, or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
receiving at a service, a contents file describing an image file to be mounted and mount information for the image file, wherein the service runs as a privileged process in user space of an operating system;
generating by the service, an image binary file based on the contents file;
determining, by a processing device, whether the image binary file is valid using the mount information; and
in response to determining that the image binary file is valid, sending a request to kernel space of the operating system to mount the image binary file.

2. The method of claim 1, wherein the mount information comprises:
a destination mount namespace for the image file; and
a mount target location for the image file.

3. The method of claim 2, wherein determining whether the image binary file is valid comprises:
determining whether the destination mount namespace is owned by a user requesting the image file to be mounted;
determining whether the mount target location is owned by the user requesting the image file to be mounted; and
determining that the image binary file is valid if the destination mount namespace and the mount target location are owned by the user requesting the image file to be mounted.

4. The method of claim 3, wherein the mount information further comprises an expected checksum of the image file.

5. The method of claim 4, wherein determining whether the image binary file is valid further comprises:
generating a checksum for the image binary file;
comparing the checksum to the expected checksum; and
determining that the image binary file is valid if the checksum and the expected checksum match.

6. The method of claim 1, wherein the contents file specifies:
a name of the image file;
a location of the image file; and
a location of the image file payload.

7. The method of claim 1, wherein the contents file comprises text information describing the image file.

8. A system comprising:
a memory; and
a processing device operatively coupled to the memory, the processing device to:
receive at a service, a contents file describing an image file to be mounted and mount information for the image file, wherein the service runs as a privileged process in user space of an operating system;
generate, by the service, an image binary file based on the contents file;
determine whether the image binary file is valid using the mount information; and
in response to determining that the image binary file is valid, send a request to kernel space of the operating system to mount the image binary file.

9. The system of claim 8, wherein the mount information comprises:
a destination mount namespace for the image file; and
a mount target location for the image file.

10. The system of claim 9, wherein to determine whether the image binary file is valid, the processing device is to:
determine whether the destination mount namespace is owned by a user requesting the image file to be mounted;
determine whether the mount target location is owned by the user requesting the image file to be mounted; and
determine that the image binary file is valid if the destination mount namespace and the mount target location are owned by the user requesting the image file to be mounted.

11. The system of claim 10, wherein the mount information further comprises an expected checksum of the image file.

12. The system of claim 11, wherein to determine whether the image binary file is valid, the processing device is further to:
generate a checksum for the image binary file;
compare the checksum to the expected checksum; and
determine that the image binary file is valid if the checksum and the expected checksum match.

13. The system of claim 8, wherein the contents file specifies:
a name of the image file;
a location of the image file; and
a location of the image file payload.

14. The system of claim 8, wherein the contents file comprises text information describing the image file.

15. A non-transitory computer-readable medium having instructions stored thereon which when executed by a processing device, cause the processing device to:
receive at a service, a contents file describing an image file to be mounted and mount information for the image file, wherein the service runs as a privileged process in user space of an operating system;
generate, by the service, an image binary file based on the contents file;
determine, by the processing device, whether the image binary file is valid using the mount information; and
in response to determining that the image binary file is valid, send a request to kernel space of the operating system to mount the image binary file.

16. The non-transitory computer-readable medium of claim 15, wherein the mount information comprises:
a destination mount namespace for the image file; and
a mount target location for the image file.

17. The non-transitory computer-readable medium of claim 16, wherein to determine whether the image binary file is valid, the processing device is to:
determine whether the destination mount namespace is owned by a user requesting the image file to be mounted;
determine whether the mount target location is owned by the user requesting the image file to be mounted; and
determine that the image binary file is valid if the destination mount namespace and the mount target location are owned by the user requesting the image file to be mounted.

18. The non-transitory computer-readable medium of claim 17, wherein the mount information further comprises an expected checksum of the image file.

19. The non-transitory computer-readable medium of claim 18, wherein to determine whether the image binary file is valid, the processing device is further to:
generate a checksum for the image binary file;
compare the checksum to the expected checksum; and
determine that the image binary file is valid if the checksum and the expected checksum match.

20. The non-transitory computer-readable medium of claim 15, wherein the contents file comprises text information describing the image file.
